(19) United States
(12) Patent Application Publication
(10) Pub. No.: US 2016/0355003 A1
(43) Pub. Date: Dec. 8, 2016

(54) METHOD OF BONDING COVER PLATE AND TOUCH SENSING FILM AND TOUCH SCREEN

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Hongqiang Luo, Beijing (CN); Ming Hu, Beijing (CN); Taofeng Xie, Beijing (CN); Zouming Zu, Beijing (CN); Wenjin Fan, Beijing (CN); Jun Xu, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei, Anhui (CN)

(21) Appl. No.: 14/891,933

(22) PCT Filed: May 12, 2015
(86) PCT No.: PCT/CN2015/078764

§ 371 Date: Nov. 17, 2015

(30) Foreign Application Priority Data
Dec. 22, 2014 (CN) 201410810272.8

(51) Int. Cl. B32B 37/12; G06F 3/041; B32B 37/10; B32B 37/06; B32B 37/14

(52) U.S. Cl. CPC B32B 37/12; B32B 37/06; B32B 37/14; B32B 37/10; G06F 3/041; B32B 2457/208; G06F 2203/04103

(57) ABSTRACT

Embodiments of the present disclosure provide a method of bonding a cover plate and a touch sensing film, and a touch screen manufactured by using the method. The method comprises steps of: bonding a cover plate and at least one touch sensing film together by an adhesive so as to form a touch module; deaerating the touch module; and laminating the deaerated touch module. The touch module is laminated after deaerating the touch module, thus water waves in the touch module may be removed, thereby increasing product yield.

### CROSS-REFERENCE TO RELATED APPLICATION

This application claims the benefit of Chinese Patent Application No. 201410810272.8 entitled “Method of Bonding Cover Plate and Touch Sensing Film and Touch Screen”, filed on Dec. 22, 2014 in the State Intellectual Property Office of China, the whole disclosure of which is incorporated herein by reference.

### BACKGROUND OF THE INVENTION

Field of the Invention

Embodiments of the present invention generally relate to field of touch screen technologies, and in particular, to a method of bonding a cover plate and a touch sensing film, and a touch screen manufactured by using the method.

Description of the Related Art

Currently, capacitive touch screens have been widely applied in electric apparatuses such as mobile phone, multimedia, public information inquiry system and the like. A conventional capacitive touch screen generally has a GG (glass cover plate plus glass cover plate) configuration by bonding a layer of cover plate glass and a layer of touch glass through an Optical Clear Adhesive (OCA). With requirements for light weight, thin thickness and low cost of touch screens, touch configurations such as GF (glass cover plate plus touch sensing film), GFF (glass cover plate plus double-layer touch sensing films), OGS (one-piece touch screen, one glass solution) have been developed.

In the GF or GFF configuration, a layer of cover plate glass and one or two layers of touch sensing films are bonded through Optical Clear Adhesive (OCA) or Optical Clear resin (OCR). These two configurations are advantageous in terms of light weight, thin thickness and low cost, and have been widely applied. However, a soft-to-hard bonding or hard-to-soft bonding operation is performed when bonding the glass cover plate and the touch film through Optical Clear Adhesive (OCA) or Optical Clear resin (OCR), which will easily result in bonding water waves, adversely affect product yield, and increase cost of the touch screen.

### SUMMARY OF THE INVENTION

Embodiments of the present disclosure provide a method of bonding a cover plate and a touch sensing film, and a touch screen manufactured by using the method, which can avoid phenomenon of forming water wave and increase product yield.

According to embodiments of one aspect of the present disclosure, there is provided a method of bonding a cover plate and a touch sensing film, comprising steps of:

bonding a cover plate and at least one touch sensing film together by an adhesive so as to form a touch module;

deaerating the touch module; and

laminating the deaerated touch module.

According to a method of one embodiment of the present disclosure, the method comprises deaerating the touch module in a closed deaerator.

According to a method of one embodiment of the present disclosure, the method comprises laminating the deaerated touch module by using two flat plates.

According to a method of one embodiment of the present disclosure, the step of laminating the deaerated touch module by using two flat plates comprises heating the touch module by at least one of the two flat plates while laminating.

According to a method of one embodiment of the present disclosure, the step of heating the touch module by at least one of the two flat plates while laminating specifically comprises:

heating at least one of the two flat plates to a predefined lamination temperature;

placing the touch module between the two flat plates; and

laminating the touch module with a predefined lamination pressure by the two flat plates for a lamination duration time.

According to a method of one embodiment of the present disclosure, the two flat plates are respectively provided therein with heating resistance wires for the heating.

According to a method of one embodiment of the present disclosure, the predefined lamination pressure is kept in a range of 1000 kg˜1200 kg, the predefined lamination temperature of the flat plate contacting the cover plate is kept in a range of 70° C.˜80° C., the predefined lamination temperature of the flat plate contacting the touch sensing film is kept in a range of 70° C.˜80° C., and the lamination duration time is kept in a range of 10 s˜80 s.

According to a method of one embodiment of the present disclosure, the predefined lamination temperature of the flat plate contacting the cover plate is kept higher than that of the flat plate contacting the touch sensing film.

According to a method of one embodiment of the present disclosure, the predefined lamination pressure is kept in a range of 1000 kg˜1200 kg, the predefined lamination temperature of the flat plate contacting the cover plate is kept in a range of 75° C.˜85° C., the predefined lamination temperature of the flat plate contacting the touch sensing film is kept in a range of 70° C.˜80° C., and the lamination duration time is kept in a range of 10 s˜80 s.

According to a method of one embodiment of the present disclosure, the step of deaerating the touch module in a closed deaerator comprises:

placing the touch module in the deaerator; and

keeping a gas pressure inside the deaerator at a predefined deaeration pressure so as to apply a pressure to the touch module for a heating and pressing duration time.

According to a method of one embodiment of the present disclosure, the step of deaerating the touch module in a closed deaerator further comprises keeping a temperature inside the deaerator at a predefined deaeration temperature.

According to a method of one embodiment of the present disclosure, the predefined deaeration pressure is set so that the touch module bears a pressure of 5 kg˜6 kg; the predefined deaeration temperature is in a range 40° C.˜60° C. ; and the heating and pressing duration time is in a range of 15 min˜45 min.

According to a method of one embodiment of the present disclosure, the step of bonding a cover plate and at least one touch sensing film together by an adhesive so as to form a touch module comprises:

plasma cleaning the cover plate;

covering the adhesive on the cover plate; and

attaching on the cover plate at least one layer of the touch sensing film which has been bonded.

According to a method of one embodiment of the present disclosure, the step of bonding a cover plate and at least one touch sensing film together by an adhesive so as to form a touch module comprises:

plasma cleaning the touch sensing film;

covering the adhesive on the touch sensing film; and

attaching the touch sensing film on the cover plate.

According to a method of one embodiment of the present disclosure, the step of bonding a cover plate and at least one touch sensing film together by an adhesive so as to form a touch module comprises:

plasma cleaning two or more touch sensing films;

covering an adhesive on the two or more touch sensing films, and bonding the two or more touch sensing films together; and

attaching the bonded two or more touch sensing films on the cover plate.

According to a method of one embodiment of the present disclosure, ultraviolet light is used to irradiate the touch module so that the adhesive is cured after the step of laminating the deaerated touch module.

According to a method of one embodiment of the present disclosure, the adhesive is a transparent adhesive.

According to a method of one embodiment of the present disclosure, the transparent adhesive comprises optical clear resin and/or optical clear adhesive.

According to a method of one embodiment of the present disclosure, the transparent adhesive comprises any one or any combination of organic silicon rubber, acrylic resin, unsaturated polyester, polyurethane and epoxy resin.

According to embodiments of another aspect of the present disclosure, there is provided a touch screen manufactured by using the method according to any one the embodiments as described above.

With the method of bonding the cover plate and the touch sensing film, and the touch screen manufactured by using the method according to the above embodiments of the present disclosure, the touch module is laminated after deaerating the touch module, so that water waves in the touch module may be removed, thereby increasing product yield.

### BRIEF DESCRIPTION OF THE DRAWINGS

In order to make the objectives, technical solutions and advantages of the present disclosure more clear and apparent, the present disclosure will be further described hereinafter in detail in combination with exemplary embodiments thereof with reference to the accompanying drawings, in which:

FIG. 1 is an operational flowchart of a method of bonding a cover plate and a touch sensing film according to a first exemplary embodiment of the present disclosure;

FIGS. 2a-2f are schematic diagrams showing operational processes of the method shown in FIG. 1, where in respective FIGS. 2a-2c and 2e-2f, the upper portions are side views, while the lower portions are top views;

FIG. 3 is an operational flowchart of a method of bonding a cover plate and a touch sensing film according to a second exemplary embodiment of the present disclosure; and

FIG. 4a-4f are schematic diagrams showing operational processes of the method shown in FIG. 3, where in respective FIGS. 4a-4c and 4e-4f, the upper portions are side views, while the lower portions are top views.

### DETAILED DESCRIPTION OF PREFERRED EMBODIMENTS OF THE INVENTION

Technical solutions of the present disclosure will be further described in detail in combination with exemplary embodiments with reference to the attached drawings. In the description, the same or like reference numbers refer to the same or like elements. The following description of exemplary embodiments of the present disclosure made with reference to the attached drawings is intended to illustrate the general inventive concepts of the present disclosure, and should not be interpreted as being limitative to the present disclosure.

According to a general inventive concept of the present disclosure, there is provided a method of bonding a cover plate and a touch sensing film, comprising steps of: bonding a cover plate and at least one touch sensing film together by an adhesive so as to form a touch module; deaerating the touch module; and laminating the deaerated touch module. The touch module is laminated after deaerating the touch module, so that water waves in the touch module may be removed, thereby increasing product yield.

In the following detailed description, for purposes of explanation, numerous specific details are set forth in order to provide a thorough understanding of the disclosed embodiments. It will be apparent, however, that one or more embodiments may be practiced or implemented without these specific details. In other instances, well-known structures and devices are schematically shown in order to simplify the drawings.

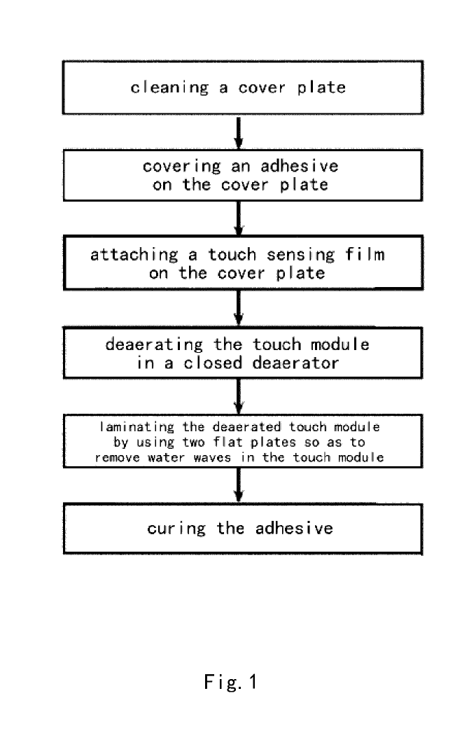

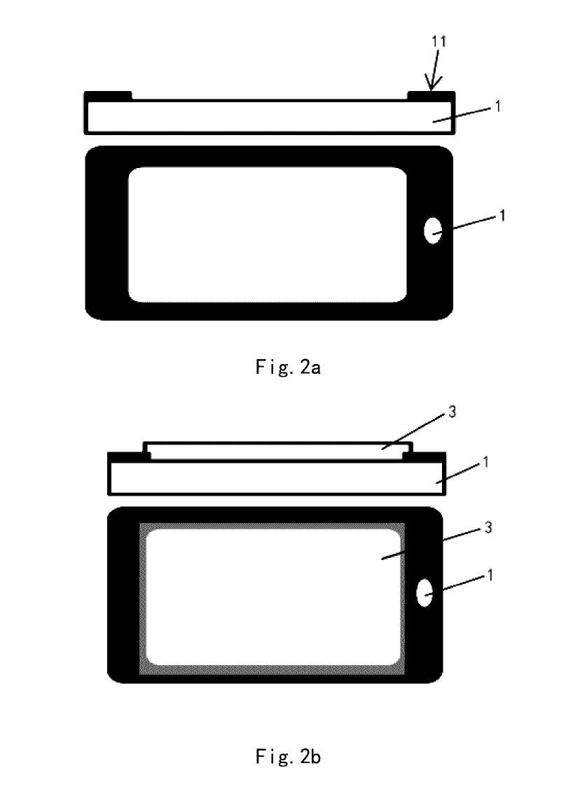

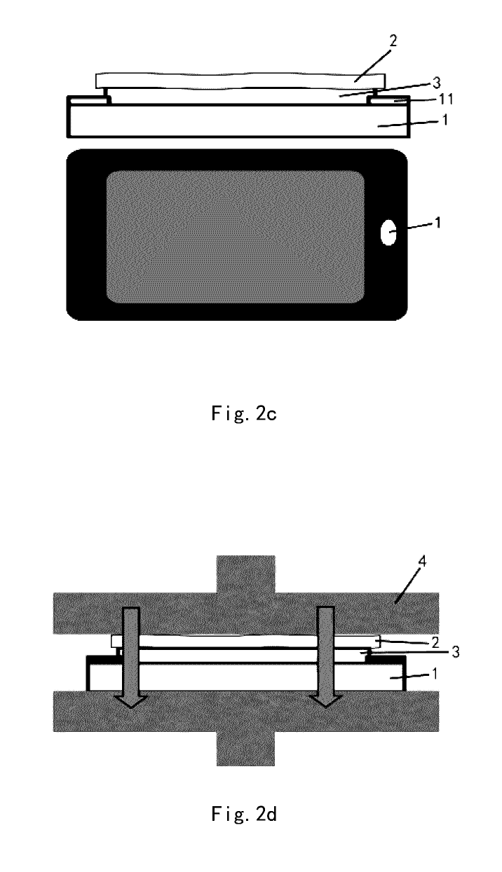

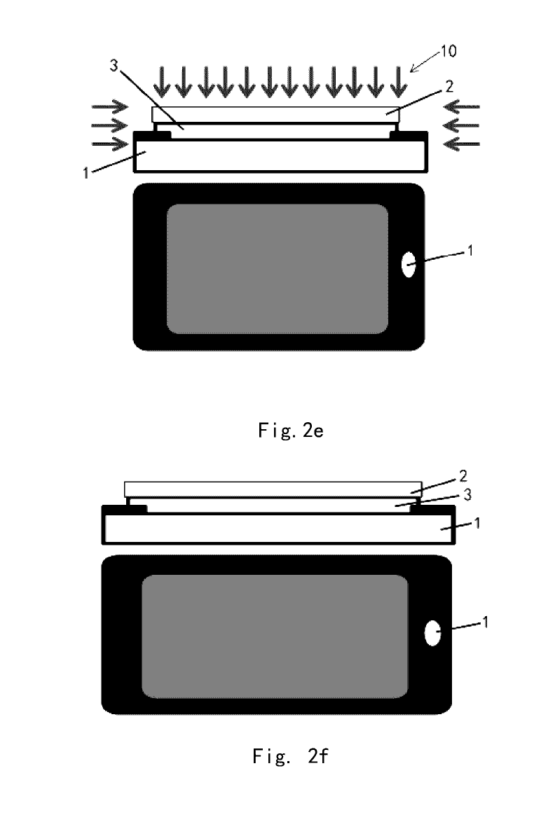

FIG. 1 is an operational flowchart of a method of bonding a cover plate and a touch sensing film according to a first exemplary embodiment of the present disclosure, FIGS. 2a-2f are schematic diagrams showing operational processes of the method shown in FIG. 1, where in respective FIGS. 2a-2c and 2e-2f, the upper portions are side views, while the lower portions are top views.

A bonding method according to an exemplary embodiment of the present disclosure comprises steps of: bonding a cover plate 1 made of, for example glass or transparent resin material, and at least one touch sensing film 2 provided with a touch sensing circuit together by a transparent adhesive 3 so as to form a touch module, as shown in FIG. 2c; deaerating the touch module in a closed deaerator (not shown); and laminating the deaerated touch module by using two flat plates 4 so as to remove water waves in the touch module, as shown in FIG. 2d. In FIG. 2d, the arrows shown in the figure represent a direction in which a pressure force is applied through the flat plates 4. The touch module is laminated by using the two flat plates after deaerating the touch module, so that water waves in the touch module may be removed, thereby increasing product yield. Further, with the method, particular air bubbles which cannot be removed in the deaerating step may be removed at this time, thereby achieving further deaeration.

In one embodiment, the step of bonding the cover plate 1 and the at least one touch sensing film 2 together by the adhesive 3 so as to form the touch module comprises: plasma cleaning the cover plate 1 so as to remove impurities on a bonding surface of the cover plate 1, such as oil, dust, water or the like, as shown in FIG. 2a; covering the adhesive 3 on the cover plate 1, for example, covering portions inside a side frame 11 of cover plate 1 and all of a display region so that the adhesive covers all of the bonding surface of the cover plate 1, as shown in FIG. 2b; and attaching the touch sensing film 2 on the cover plate 1, as shown in FIG. 2c.

As shown in FIG. 2e, after the step of laminating the deaerated touch module by using the two flat plates 4, ultraviolet light 10 is used to irradiate the touch module so that the adhesive 3 is cured, thereby obtaining the touch screen shown in FIG. 2f.

Specifically, with reference to FIG. 1 and FIGS. 2a-2f, the bonding method according to the first exemplary embodiment of the present disclosure comprises steps of: plasma cleaning the cover plate 1, as shown in FIG. 2a; covering the adhesive 3 on the cover plate 1, as shown in FIG. 2b; attaching the touch sensing film 2 onto the cover plate 1, as shown in FIG. 2c; deaerating the touch module in a closed deaerator (not shown); and laminating the deaerated touch module by using two flat plates 4 so as to remove water waves in the touch module, as shown in FIG. 2d; irradiate the touch module by using ultraviolet light 10 so that the adhesive 3 is cured, as shown in FIG. 2e; and finally, obtaining the touch screen shown in FIG. 2f.

In the above embodiment, the touch sensing film 2 may include one layer of touch sensing film, or may also include two or more layers of touch sensing films previously bonded together.

In one embodiment, as shown in FIG. 2d, the step of laminating the deaerated touch module by using the two flat plates 4 so as to remove water waves in the touch module comprises heating the touch module by at least one of the two flat plates 4, which have planar surfaces and are parallel to each other, while laminating. A greater force is applied by the two flat plates 4 so as to effectively remove water waves in the touch module. With this method, particular air bubbles which are not removed in the deaerating step may be removed, thereby achieving further deaeration.

In one exemplary embodiment, the step of laminating the deaerated touch module by using the two flat plates 4 so as to remove water waves in the touch module specifically comprises: heating at least one of the two flat plates 4 to a predefined lamination temperature; placing the touch module between the two flat plates 4; and laminating the touch module with a predefined lamination pressure by the two flat plates 4 for a lamination duration time. As such, the water waves may be effectively removed by controlling the lamination pressure, temperature and time, while keeping or not affecting functions of the cover plate 1 and the touch sensing film 2. For example, the two flat plates 4 are respectively provided therein with heating resistance wires (not shown), so that the heating time may be controlled easily by controlling a voltage applied on the resistance wires.

In one embodiment, the predefined lamination pressure is kept in a range of 1000 kg˜1200 kg, the predefined lamination temperature of the flat plate 4 (for example, the lower flat plate shown in FIG. 2d) contacting the cover plate 1 is kept in a range of 70° C.˜80° C., the predefined lamination temperature of the flat plate 4 (for example, the upper flat plate shown in FIG. 2d) contacting the touch sensing film 2 is kept in a range of 70° C.˜80° C., and the lamination duration time is kept in a range of 10 s·80 s. As such, the water waves may be effectively removed and particular air bubbles which are not removed in the deaerating step may be further removed by setting appropriate laminating conditions, while keeping functions of the cover plate 1 and the touch sensing film 2. It will be appreciated that the above is only an example, and the present disclosure is not limited to the above specific value ranges.

In one alternative embodiment, the predefined lamination temperature of the flat plate 4 (for example, the upper flat plate shown in FIG. 2d) contacting the cover plate 1 is higher than that of the flat plate 4 (for example, the upper flat plate shown in FIG. 2d) contacting the touch sensing film 2. For example, the predefined lamination pressure is kept in a range of 1000 kg˜1200 kg, the predefined lamination temperature of the flat plate contacting the cover plate is kept in a range of 75° C.˜85° C., the predefined lamination temperature of the flat plate contacting the touch sensing film is kept in a range of 70° C.˜80° C., and the lamination duration time is kept in a range of 10 s˜80 s. Compared to the cover plate 1, the touch sensing film 2 has smaller thickness and thermal expansion ratio and is provided therein with a touch sensing circuit (s), thus setting the temperature of the flat plate 4 (for example, the lower flat plate shown in FIG. 2d) contacting the touch sensing film 2 to be lower facilitate to keep the temperature of the adhesive 3 uniform and to keep performances of the touch sensing circuit (s) reliable. It will be appreciated that the above is only an example, and the present disclosure is not limited to the above specific value ranges.

In one embodiment, the step of deaerating the touch module in a closed deaerator (not shown) comprises: placing the touch module in the deaerator; and keeping a gas pressure inside the deaerator at a predefined deaeration pressure so as to apply a pressure to the touch module for a heating and pressing duration time. Through deaeration, air bubbles, which are generated in the touch module due to non-uniform force and/or non-uniform heat during bonding the touch sensing film 2 to the cover plate 1, may be removed, so that product yield is increased.

In a further embodiment, the step of deaerating the touch module in a closed deaerator further comprises keeping a temperature inside the deaerator at a predefined deaeration temperature. For example, the predefined deaeration pressure is set so that the touch module bears a pressure of 5 kg˜6 kg; the predefined deaeration temperature is in a range 40° C.˜60° C. ; and the heating and pressing duration time is in a range of 15 min˜45 min. As such, the efficiency of removing air bubbles may be improved through pressing and heating.

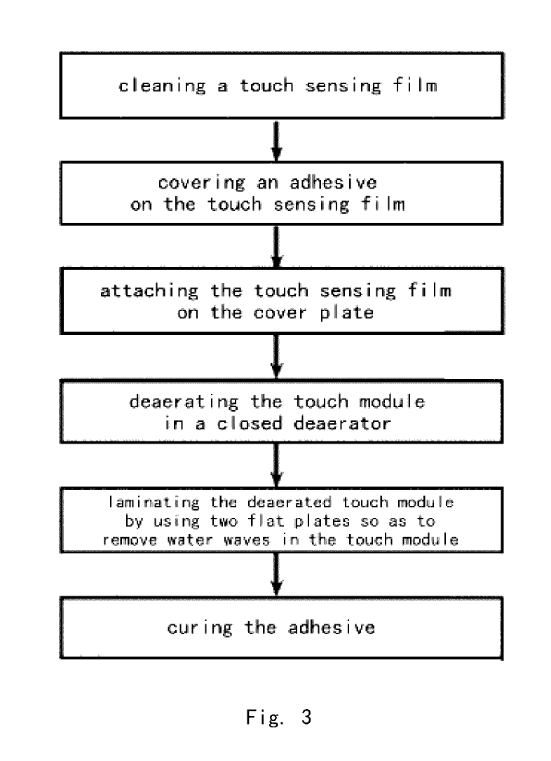

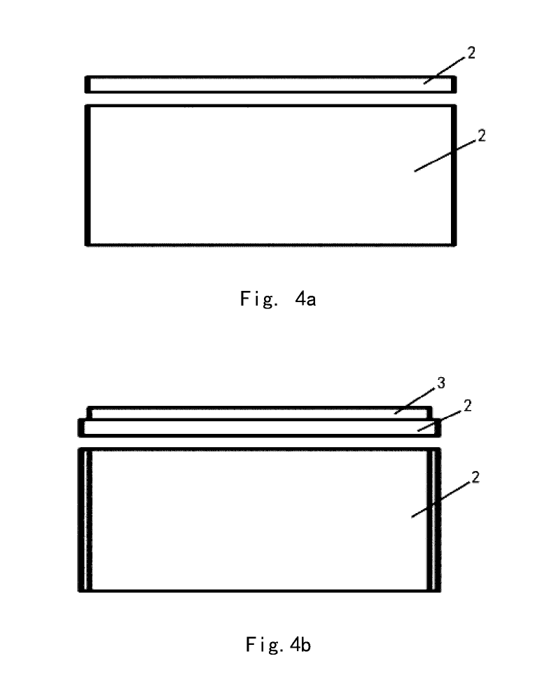

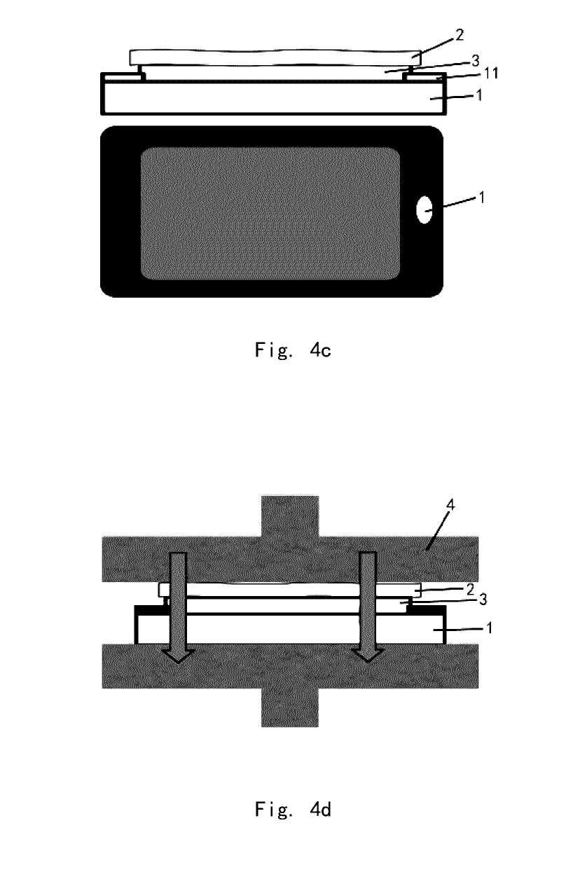

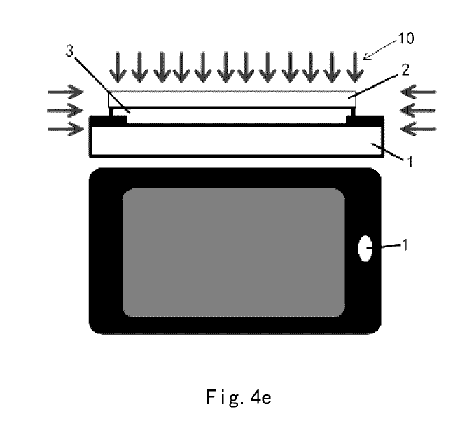

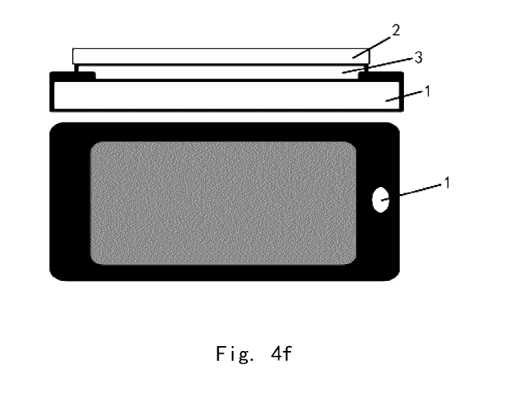

FIG. 3 is an operational flowchart of a method of bonding a cover plate and a touch sensing film according to a second exemplary embodiment of the present disclosure; FIG. 4a-4f are schematic diagrams showing operational processes of the method shown in FIG. 3, where in respective FIGS. 4a-4c and 4e-4f, the upper portions are side views, while the lower portions are top views. In the method for bonding according to the second embodiment, the step of bonding the cover plate 1 and at least one touch sensing film together by the adhesive so as to form a touch module comprises: plasma cleaning one touch sensing film 2 so as to remove impurities on a bonding surface of the touch sensing film 2, such as oil, dust, water or the like, as shown in FIG. 4a; covering the adhesive 3 on the touch sensing film 2, for example, as shown in FIG. 4b; and attaching the touch sensing film 2 on the cover plate 1, as shown in FIG. 4c.

Specifically, with reference to FIG. 3 and FIGS. 4a-4f, the method for bonding according to the second exemplary embodiment of the present disclosure comprises steps of: plasma cleaning one touch sensing film 2, as shown in FIG. 4a; covering the adhesive 3 on the touch sensing film 2, as shown in FIG. 4b; attaching the touch sensing film 2 onto the cover plate 1, as shown in FIG. 4c; deaerating the touch module in a closed deaerator (not shown); and laminating the deaerated touch module by using two flat plates 4 so as to remove water waves in the touch module, as shown in FIG. 4d (the arrows shown in the figure represent a direction in which a pressure is applied); irradiate the touch module by using ultraviolet light 10 so that the adhesive 3 is cured, as shown in FIG. 4e; and finally, obtaining a GF touch screen shown in FIG. 4f.

Although in the above second embodiment, an example in which one layer of touch sensing film is bonded onto the cover plate 1 so as to form the GF touch screen is described, the present disclosure is not limited to this. In a variation embodiment of the second embodiment, the step of bonding the cover plate and at least one touch sensing film together by a transparent adhesive so as to form the touch module comprises: plasma cleaning two or more touch sensing films; covering the adhesive on the two or more touch sensing films, and bonding the two or more touch sensing films together; and attaching the bonded two or more touch sensing films on the cover plate. As such, a GFF touch screen or GFS touch screen may be manufactured.

In one embodiment, the transparent adhesive comprises Optical Clear Resin (OCR) and/or Optical Clear Adhesive (OCA). The adhesive may also comprise any one of adhesives such as organic silicon rubber, acrylic resin, unsaturated polyester, polyurethane and epoxy resin and the like or any combination thereof.

It is noted herein that the touch screen in respective embodiments of the present disclosure is a capacitive touch screen, but the present disclosure is not limited to this. The method described in the present disclosure is also applicable if a cover plate and a touch module need to be bonded in other types of touch screens (for example, resistive touch screen, inductive touch screen).

According to an embodiment of a further aspect of the present disclosure, there is provided a touch screen manufactured by the method according to any one of the above embodiments. Such a touch screen may be a touch screen based on a capacitance sensing principle, or may also be a touch screen based on a resistance sensing principle. This touch screen may be applied in a display device. The display device may be any other products or components having a display function, such as a mobile phone, a tablet computer, a TV, a display, a notebook computer, a digital picture frame, a navigator, an electronic paper or the like.

With the method of bonding the cover plate and the touch sensing film, and the touch screen manufactured by using the method according to the above embodiments of the present disclosure, the touch module is laminated by using two flat panels after deaerating the touch module, so that water waves in the touch module may be removed, while particular air bubbles which are not removed in the deaerating step may be removed with this method, thereby increasing product yield.

Having further described the objectives, technical solutions and advantageous effects of the present disclosure in detail in the above exemplary embodiment, it will be appreciated that the above described contents are only specific embodiments of the present disclosure, and are not intended to limit the present disclosure. All changes, equivalent alternatives or modifications which are made the principles and spirit of the present disclosure should fall within the scopes of the present invention.

1. A method of bonding a cover plate and a touch sensing film, comprising steps of:
bonding a cover plate and at least one touch sensing film together by an adhesive so as to form a touch module;
deaerating the touch module; and
laminating the deaerated touch module.

2. The method according to claim 1, comprising deaerating the touch module in a closed deaerator.

3. The method according to claim 1, comprising laminating the deaerated touch module by using two flat plates.

4. The method according to claim 3, wherein the step of laminating the deaerated touch module by using two flat plates comprises heating the touch module by at least one of the two flat plates while laminating.

5. The method according to claim 4, wherein the step of heating the touch module by at least one of the two flat plates while laminating further comprises:
heating at least one of the two flat plates to a predefined lamination temperature;
placing the touch module between the two flat plates; and
laminating the touch module with a predefined lamination pressure by the two flat plates for a lamination duration time.

6. The method according to claim 5, wherein the two flat plates are respectively provided therein with heating resistance wires for the heating.

7. The method according to claim 5, wherein the predefined lamination pressure is kept in a range of 1000 kg˜1200 kg, the predefined lamination temperature of the flat plate contacting the cover plate is kept in a range of 70° C.˜80° C., the predefined lamination temperature of the flat plate contacting the touch sensing film is kept in a range of 70° C.˜80° C., and the lamination duration time is kept in a range of 10 s˜80 s.

8. The method according to claim 5, wherein the predefined lamination temperature of the flat plate contacting the cover plate is kept higher than that of the flat plate contacting the touch sensing film.

9. The method according to claim 8, wherein the predefined lamination pressure is kept in a range of 1000 kg˜1200 kg, the predefined lamination temperature of the flat plate contacting the cover plate is kept in a range of 75° C.˜85° C., the predefined lamination temperature of the flat plate contacting the touch sensing film is kept in a range of 70° C.˜80° C., and the lamination duration time is kept in a range of 10 s˜80 s.

10. The method according to claim 2, wherein the step of deaerating the touch module in a closed deaerator comprises:
placing the touch module in the deaerator; and
keeping a gas pressure inside the deaerator at a predefined deaeration pressure so as to apply a pressure to the touch module for a heating and pressing duration time.

11. The method according to claim 10, wherein the step of deaerating the touch module in a closed deaerator further comprises keeping a temperature inside the deaerator at a predefined deaeration temperature.

12. The method according to claim 11, wherein the predefined deaeration pressure is set so that the touch module bears a pressure of 5 kg˜6 kg; the predefined deaeration temperature is in a range 40° C.˜60° C.; and the heating and pressing duration time is in a range of 15 min˜45 min.

13. The method according to claim 1, wherein the step of bonding a cover plate and at least one touch sensing film together by an adhesive so as to form a touch module comprises:
plasma cleaning the cover plate;
covering the adhesive on the cover plate; and
attaching on the cover plate at least one layer of the touch sensing film which has been bonded.

14. The method according to claim 1, wherein the step of bonding a cover plate and at least one touch sensing film together by an adhesive so as to form a touch module comprises:
plasma cleaning the touch sensing film;
covering the adhesive on the touch sensing film; and
attaching the touch sensing film on the cover plate.

15. The method according to claim 1, wherein the step of bonding a cover plate and at least one touch sensing film together by an adhesive so as to form a touch module comprises:
plasma cleaning two or more touch sensing films;
covering the adhesive on the two or more touch sensing films, and bonding the two or more touch sensing films together; and
attaching the bonded two or more touch sensing films on the cover plate.

16. The method according to claim 1, wherein ultraviolet light is used to irradiate the touch module so that the adhesive is cured after the step of laminating the deaerated touch module.

17. The method according to claim 1, wherein the adhesive is a transparent adhesive.

18. The method according to claim 17, wherein the transparent adhesive comprises optical clear resin and/or optical clear adhesive.

19. The method according to claim 18, wherein the transparent adhesive comprises any one or any combination of organic silicon rubber, acrylic resin, unsaturated polyester, polyurethane and epoxy resin.

20. A touch screen, manufactured by using the method according to claim 1.
